(19) United States
(12) Patent Application Publication
(10) Pub. No.: US 2019/0026688 A1
(43) Pub. Date: Jan. 24, 2019

(54) ARTICLE TRANSPORTING METHOD AND RELATED DEVICE

(71) Applicant: CAINIAO SMART LOGISTICS HOLDING LIMITED, Grand Cayman (KY)

(72) Inventors: JIE LIU, HANGZHOU (CN); JUNBO CHEN, HANGZHOU (CN); CHENGXING ZHONG, HANGZHOU (CN); QIANG FANG, HANGZHOU (CN)

(21) Appl. No.: 16/039,101

(22) Filed: Jul. 18, 2018

(30) Foreign Application Priority Data
Jul. 20, 2017 (CN) 201710595508.4

(51) Int. Cl. G06Q 10/08; G06K 17/00; G06K 19/07

(52) U.S. Cl. CPC G06Q 10/087; G06K 17/0032; G06K 2017/0048; G06K 2017/0051; G06K 19/0723

(57) ABSTRACT

This application provides an article transporting method. In this method, one or more articles can be placed in an article storage unit disposed in a transporting vehicle and a tag is disposed on an article. A tag information acquisition unit is disposed in the transporting vehicle, and tag information of each article in the article storage unit may be acquired and uploaded to a server. After the transporting vehicle arrives at a receiving location of a specific article, the server can determine, by comparing tag information in the article storage unit before article transporting of the transporting vehicle with tag information in the article storage unit after an article is taken away at the receiving location, an article that is taken away by a user, and further, compares the article that is taken away with a to-be-received article at this receiving location, to determine whether the article taken away by the user is correct. In view of this, this application can ensure accuracy of pick-up of a user while improving a utilization ratio of the article storage unit.

### CROSS REFERENCE TO RELATED APPLICATION

The present application is based on and claims priority to Chinese Patent Application No. 201710595508.4, filed on Jul. 20, 2017, which is incorporated herein by reference in its entirety.

### TECHNICAL FIELD

This application relates to the field of logistics technologies, and more specifically, to an article transportation method and a related device.

### BACKGROUND

In the field of logistics, a logistic parcel usually needs to be subject to several sessions such as receiving, shipping, transporting, delivery, and sign-off. The delivery may also be referred to as distribution and means that after a logistic parcel arrives at a logistic outlet of an area where a recipient is, a courier delivers the logistic parcel to a receiving address of the recipient. Although manual distribution by the courier is relatively flexible, labor costs are costly.

To reduce labor costs of delivery to some extent, self-pick-up cabinets are disposed on some sites. A courier places a logistic parcel inside a parcel cabinet, usually one express parcel is placed in one locker of the parcel cabinet, and a recipient of the express parcel is notified to pick up the logistic parcel from the self-pick-up cabinet. However, such a manner has many uncertainty problems such as a long turnaround time of the self-pick-up cabinet and a low space utilization ratio of a locker.

Therefore, another solution is needed to reduce costs of manual distribution. Currently, logistic robots are configured on some sites such as industrial parks and office buildings. A logistic robot is provided with a drawer, a logistic parcel is placed inside the drawer, and the logistic robot transports the logistic parcel from a logistic outlet to a receiving location of a recipient. However, in such a manner, after the logistic robot arrives at the receiving location, the logistic parcel received by the recipient might not belong to the recipient. That is, a situation of a parcel pick-up error may occur.

### SUMMARY

The present application provides an article transporting method, to ensure accuracy of delivery of an article by a logistic robot.

To achieve the objective, technical solutions provided by this application are as follows:

According to a first aspect, this application provides an article transporting method to be implemented by a server. The method includes providing a first article set corresponding to a transporting vehicle, receiving a second article set corresponding to the transporting vehicle that is sent by the transporting vehicle, determining a target article, determining a difference article between the first article set and the second article set, and determining whether the difference article is the target article, and sending determining result information to the transporting vehicle.

According to a second aspect, this application provides an article transporting method to be implemented by a transporting vehicle. The method includes obtaining a first article set transported by the transporting vehicle, and sending the first article set corresponding to the transporting vehicle to a server, obtaining a second article set corresponding to the transporting vehicle when a preset condition is satisfied, and sending the second article set corresponding to the transporting vehicle to the server. The second article set is provided for the server to determine a corresponding target article. The first article set and the second article set are provided for the server to determine a difference article, determine whether the difference article is the target article, and send determining result information to the transporting vehicle. The method may further include receiving and outputting the result information.

According to a third aspect, this application provides an article transporting method to be implemented by a transporting vehicle. The method includes obtaining a first article transported by the transporting vehicle, after a preset condition is satisfied, obtaining a second article set corresponding to the transporting vehicle, determining a target article, determining a difference article between the first article set and the second article set, and determining whether the difference article is the target article and outputting a determining result.

According to a fourth aspect, this application provides a server, including a memory, configured to provide a first article set corresponding to a transporting vehicle, a communications interface, configured to receive a second article set corresponding to the transporting vehicle that is sent by the transporting vehicle, and a processor, configured to determine a target article; determine a difference article between the first article set and the second article set, determine whether the difference article is the target article, and generate determining result information. The communications interface is further configured to send the result information to the transporting vehicle.

According to a fifth aspect, this application provides a transporting vehicle, including an article information acquisition unit, configured to obtain a first article transported by the transporting vehicle, a communications interface, configured to send the first article set corresponding to the transporting vehicle to a server. The article information acquisition unit is further configured to, after a preset condition is satisfied, obtain a second article set corresponding to the transporting vehicle. The communications interface is further configured to send the second article set corresponding to the transporting vehicle to the server. The second article set is provided for the server to determine a corresponding target article. The first article set and the second article set are provided for the server to: determine a difference article, determine whether the difference article is the target article, and send determining result information to the transporting vehicle. The transporting vehicle further includes an outputting unit configured to receive and output the result information.

According to a sixth aspect, this application provides a transporting vehicle, including an article information acquisition unit, configured to obtain a first article transported by the transporting vehicle, and after a preset condition is satisfied, obtain a second article set corresponding to the transporting vehicle. The transporting vehicle further includes a processor configured to determine a target article, determine a difference article between the first article set and the second article set, and determine whether the difference article is the target article, and obtain a determining result. The transporting vehicle further includes an outputting unit, configured to output the determining result.

It can be learned from the foregoing technical solutions that in some embodiments of the present application, the server pre-records a first article set corresponding to the transporting vehicle. The first article set is used for representing an article set carried by the transporting vehicle before an article is delivered. The server can receive a second article set sent by the receiving transporting vehicle, where the article set is an article set after an article is delivered by the transporting vehicle. The server can determine, according to the second article set, a delivered target article, determine a difference article between the first article set and the second article set, and determine whether the difference article is the target article, so that whether an accurate article is taken away from the transporting vehicle can be determined according to a determining result.

### BRIEF DESCRIPTION OF THE DRAWINGS

To illustrate the technical solutions of the embodiments of present application or in the prior art more clearly, the accompanying drawings for describing the embodiments of the present application or the prior art are briefly introduced below. Apparently, the accompanying drawings in the following description are merely some embodiments of this application, and a person of ordinary skill in the art can derive other accompanying drawings from the accompanying drawings without inventive efforts.

FIG. 1 is a schematic structural diagram of an article transporting system according to this application;

FIG. 2 is a flowchart of an article transporting method according to this application;

FIG. 3 is a schematic structural diagram of a transporting vehicle according to this application;

FIG. 4 is a schematic structural diagram of hardware of a server according to this application;

FIG. 5 is a schematic structural diagram of hardware of a transporting vehicle according to this application;

FIG. 6 is another schematic structural diagram of hardware of a transporting vehicle according to this application; and

FIG. 7 is still another schematic structural diagram of hardware of a transporting vehicle according to this application.

### DETAILED DESCRIPTION

The following clearly and completely describes the technical solutions in the embodiments of this application with reference to the accompanying drawings in the embodiments of this application. Apparently, the described embodiments are merely some but not all of the embodiments of this application. All other embodiments obtained by persons of ordinary skill in the art based on the embodiments of the present application without creative efforts shall fall within the protection scope of the present application.

In the field of logistics, a logistic parcel often needs to be subject to a delivery session. To reduce manual delivery costs, a transporting vehicle is provided on some sites, and is configured to transport a logistic parcel to a preset receiving location of the logistic parcel. The transporting vehicle may transport a plurality of logistic parcels, and after the transporting vehicle transports the plurality of logistic parcels to a receiving location, a user may take a logistic parcel that is not supposed to be delivered to that receiving location.

Therefore, to improve delivery accuracy of a logistic parcel, this application provides an article transporting system. It should be noted that an application scenario of the article transporting system is not limited to transporting a logistic parcel, and other articles can also be transported.

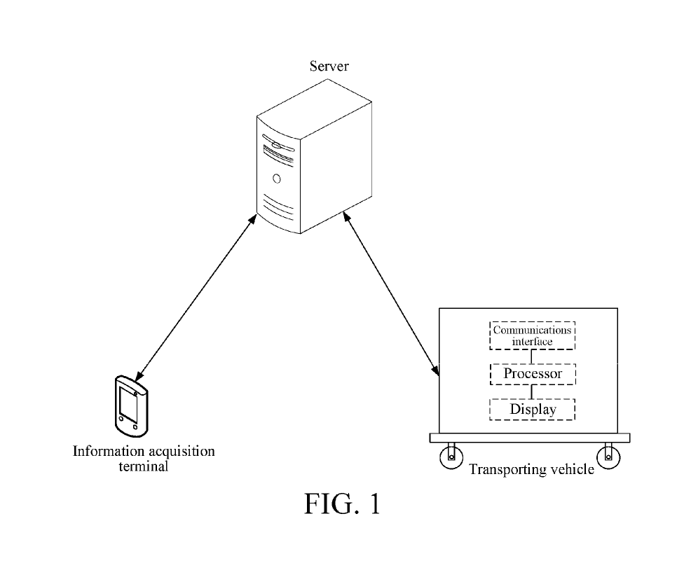

The article transporting system provided by this application, as shown in FIG. 1, specifically includes a transporting vehicle, an information acquisition terminal, and a server. The transporting vehicle may be a mobile device having a bearing apparatus, and a specific form thereof is a mobile robot. In one embodiment, the transporting vehicle and the information acquisition terminal are separately connected to the server. The server may be one or more computer device.

Before being transported, an article may be placed at a preset location. After arriving at the preset location, the transporting vehicle may carry out an article transporting task to transport the article. The article may have uniquely corresponding tag information and uniquely corresponding scan code information. The article transporting task may be briefly referred to as a transporting task, and the tag information may be referred to as an article tag.

The information acquisition terminal is configured to acquire the tag information and the scan code information of the article in the transporting task, and send the tag information and the scan code information to the server. The server is configured to establish and store a correspondence between the tag information and the scan code information. An article storage unit configured to store the article is disposed in the transporting vehicle. A tag is disposed on the article. A tag acquisition unit is disposed inside the article storage unit, and the tag acquisition unit can acquire tag information of the article stored inside the article storage unit.

Before carrying out the transporting task, the transporting vehicle sends tag information of a loaded article to the server, and the server stores the tag information. After the transporting vehicle moves to a receiving location of an article, a user can take away the article in the article storage unit, and the transporting vehicle acquire the tag information of the article inside the article storage unit again, and send the acquired tag information to the server again. The server compares the tag information acquired again with the stored tag information, to determine the tag information of the article taken away by the user. Then, scan code information corresponding to the tag information of the article taken away is determined according to a correspondence between tag information and scan code information, and whether the scan code information is the scan code information of the article corresponding to the receiving location is determined. It can be determined, according to a determining result, whether the article taken away by the user from the transporting vehicle is accurate.

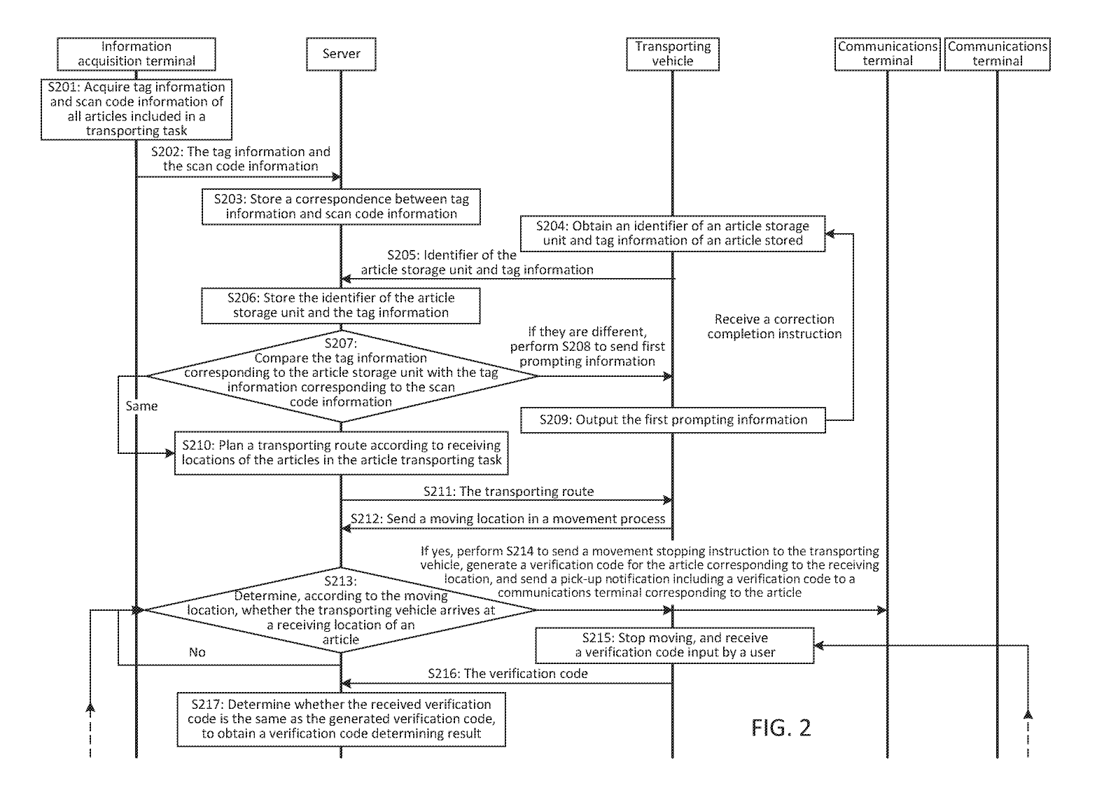

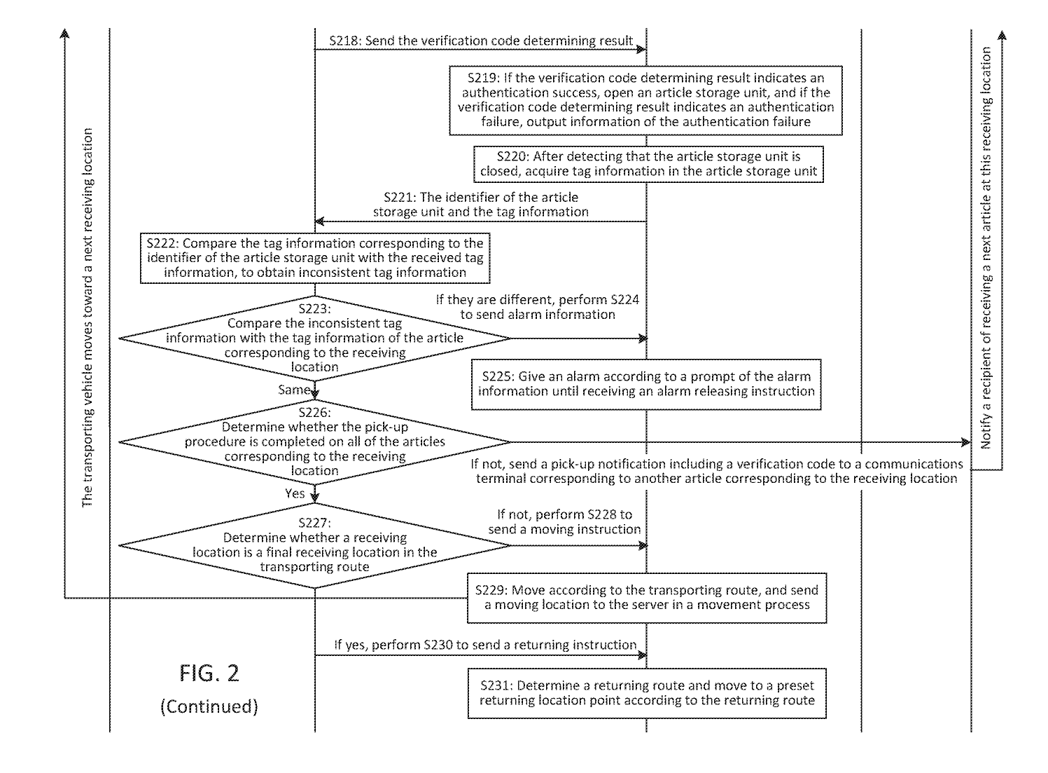

Based on the foregoing article transporting system, this application further provides an article transporting method. As shown in FIG. 2, the article transporting method includes the following steps S201 to S232.

S201: An information acquisition terminal acquires tag information and scan code information of all articles included in a transporting task.

Before being transported, an article may be placed at a preset location. A transporting vehicle, after arriving at the preset location, may start to carry out an article transporting task. However, a plurality of articles may be placed at the preset location. In this case, it is needed to determine which article to be transported in this transporting task for the transporting vehicle. Determining the article in a transporting task may be carried by a server.

Specifically, an article has a preset receiving location. To improve transporting efficiency, the server regards articles whose receiving locations are in a same area as articles of one transporting task. Certainly, division of a same area can be performed according to actual situations. No specific limitation is made in this application. For example, a same floor or a same building can be regarded as a same area.

Articles in one transporting task are assigned to one transporting vehicle. In consideration of that an article storage unit (such as a drawer) in the transporting vehicle has requirements on aspects such as a weight, a size, and a quantity, when determining articles in a transporting task, the server also needs to ensure that a total weight of all articles in the transporting task satisfies a weight condition corresponding to the transporting vehicle, a size of each article in the transporting task needs to satisfy a size condition corresponding to the transporting vehicle, and a total quantity of all the articles in the transporting task satisfies a quantity condition corresponding to the transporting vehicle. Certainly, when determining articles in a transporting task, the server may use one or more of a receiving location, a weight, a size, and a quantity as a condition or conditions, or one or more other transporting condition may be included according to actual situation. It does not matter which form a transporting condition is in, as long as the server can determine articles that satisfy the transporting conditions.

After determining articles in the transporting task, the server sends the transporting task to the transporting vehicle. Certainly, to simplify an implementation, which articles need to be transported by the transporting vehicle may alternatively be determined manually.

After determining the to-be-transported articles, it is needed to dispose tags on the articles. For example, an operator sticks tags to the to-be-transported articles. The tag for each article may be unique. For example, the tag can a radio frequency identification (RFID) tag. Certainly, the tag is not limited thereto, and may alternatively be a tag using a radio frequency technology such as near field communication (NFC). A tag acquisition unit may be disposed inside the information acquisition terminal, and is configured to acquire tag information.

The article is also provided with a scan code such as a two-dimensional barcode or a barcode image. A scan code acquisition module may alternatively be disposed inside the information acquisition terminal, and is configured to acquire scan code information. The scan code information includes basic information of an article such as a unique identifier of an article.

It should be noted that disposing tags on the articles may be, but is not limited, after the to-be-transported articles are determined, and may alternatively before the to-be-transported articles are determined. That is, the articles have been provided with scan codes and tags. After articles in this transporting task are determined, an operator may acquire tag information and scan code information of the articles by directly using the information acquisition terminal.

S202: The information acquisition terminal sends the tag information and the scan code information of the articles to a server.

After acquiring tag information and scan code information of a same article in the transporting task, the information acquisition terminal sends the tag information and the scan code information together or separately to the server. If the tag information and the scan code information are separately sent to the server, it is needed to clearly indicate that the tag information and the scan code information correspond to a same article, to notify the server that the tag information and the scan code information that are separately sent are information of the same article.

In actual applications, a same tag is likely to be acquired multiple times. For example, after tag information of a specific article is acquired, and when an operator acquires tag information of another article, the operator may mistakenly acquire tag information of the previous article. Therefore, before the sending, to ensure consistency between an article and tag information, after the tag information is acquired, it is checked whether the same tag information as the acquired tag information has been acquired before, and if it has not been acquired before, the tag information and the scan code information can be sent to the server.

In addition, the information acquisition terminal may send tag information and scan code information of one article each time, and may alternatively send tag information and scan code information of a plurality of articles. In one embodiment, the information acquisition terminal send tag information and scan code information of all articles in a transporting task to the server.

In one exemplary embodiment, a transporting task includes seven articles, and tag information and scan code information of the seven articles are: [001,aaa], [002,bbb], [003,ccc], [004,ddd], [005,eee], [006,fff], and [007,ggg].

S203: The server stores a correspondence between tag information and scan code information of an article.

If the server receives the tag information and the scan code information that are sent together, the server can establish a correspondence between the tag information and the scan code information. If the server receives the tag information and the scan code information separately, the server determines tag information and scan code information of a same article, and establishes a correspondence between the tag information and the scan code information of the same article. The correspondence between the tag information and the scan code information is established and the stored.

Certainly, the information acquisition terminal may also send information on the correspondence relationship between the tag information and the scan code information to the server.

It should be noted that in step S201, the operator uses the information acquisition terminal to acquire tag information and scan code information of all articles in this transporting task of the transporting vehicle, and in step S202, the information acquisition terminal also sends tag information and scan code information corresponding to each article to the server. In this way, in step S203, the server establishes a correspondence between the tag information and the scan code information of each article. That is, if the transporting task includes a plurality of articles, a correspondence between scan code information and tag information of each article is established. For example, correspondences between tag information and scan code information established by the server for seven articles are: 001-aaa, 002-bbb, 003-ccc, 004-ddd, 005-eee, 006-fff, and 007-ggg.

The correspondences may be used for checking whether all the articles in the transporting task are placed into the article storage unit after the articles are unloaded from the transporting vehicle, and may be used for performing accuracy verification when a recipient picks up an article. Refer to the following description for a specific process.

S204: A transporting vehicle obtains an identifier of an article storage unit, and acquires tag information of an article stored in the article storage unit.

On a site of the transporting vehicle, after acquiring tag information and scan code information of each article, an operator places the article into the article storage unit of the transporting vehicle. Specifically, the article storage unit of the transporting vehicle may be set in a form in which an instruction is needed for opening or closing the article storage unit. Correspondingly, a human-machine interface may be further disposed on the transporting vehicle, an operator may input a drawer opening or closing instruction to the transporting vehicle according to the human-machine interface, to open or close the article storage unit.

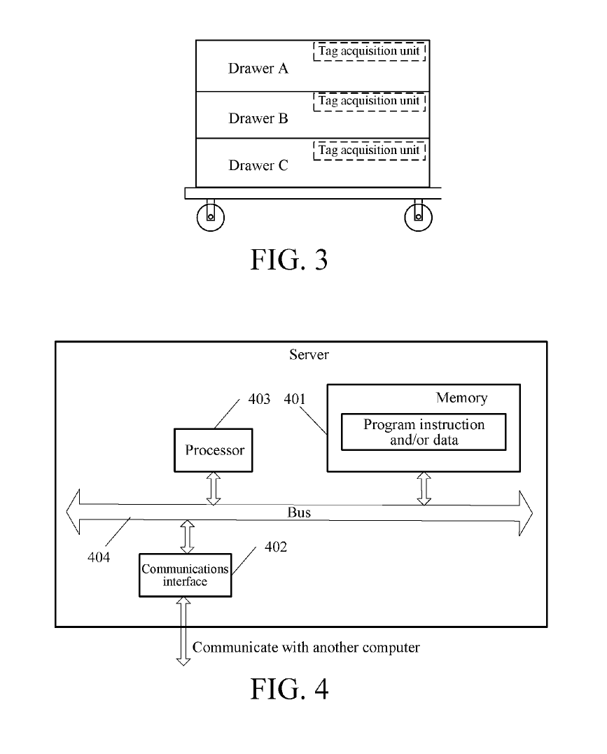

One embodiment of the article storage unit disposed in the transporting vehicle is shown in FIG. 3. In this embodiment, the transporting vehicle is provided with three drawers, namely, a drawer A, a drawer B, and a drawer C. The three drawers are arranged layer by layer, the drawers are used for storing logistic parcels, and a tag acquisition unit is disposed in each drawer. In addition, a display screen may be further disposed on the transporting vehicle. The display screen may display icons of all drawers disposed in the transporting vehicle. The operator may click an icon of a specific drawer, and the transporting vehicle opens a drawer corresponding to the clicked drawer icon, so that the operator may place a logistic parcel into the drawer. When the operator completely places the logistic parcel into the drawer, and needs to close the drawer, the operator may further click the icon of the drawer again, according to the foregoing operation procedure, to close the drawer. Certainly, the form of the article storage unit is not limited to a drawer and may be another form, and an arrangement manner is also not limited to an arrangement manner shown in FIG. 3. In addition, the display screen may alternatively be an independent terminal such as a tablet computer, and the terminal is attached to the transporting vehicle in a mechanical attaching manner.

After placing the article into the article storage unit, the operator may input an acquisition instruction to the transporting vehicle, to instruct the transporting vehicle to acquire tag information of the article stored in each article storage unit. The acquisition instruction may be the foregoing instruction for closing the article storage unit. That is, after being closed, the article storage unit can perform an acquisition action. Certainly, the acquisition instruction may alternatively be an independent instruction rather than the closing instruction.

Specifically, a tag information acquisition unit is disposed inside the article storage unit of the transporting vehicle. After an article is placed into the article storage unit, the tag information acquisition unit may acquire tag information disposed on the article placed into the article storage unit. For example, the tag disposed on the article may be an RFID TAG. The tag information acquisition unit disposed inside the drawer of the transporting vehicle is an RFID TAG acquisition unit. After the operator places the article into the drawer and closes the drawer, the RFID TAG acquisition unit may acquire tag information of the RFID TAG on the article. To ensure that the tag information acquisition unit can accurately acquire tag information of each article placed into the article storage unit, when the operator places the article into the article storage unit, the operator may direct a face having the tag of the article toward the tag information acquisition unit based on a location of the tag information acquisition unit.

The article storage units disposed on the transporting vehicle each separately correspond to a unique identifier. Using the transporting vehicle in FIG. 3 as an example, the drawers are identified with tags A, B, and C. Certainly, an identifier form may be another form and is not limited to a letter. When acquiring tag information inside the article storage unit, the transporting vehicle also needs to acquire a tag of the article storage unit.

The identifier of each article storage unit acquired by the transporting vehicle corresponds to the tag information inside the article storage unit, and this correspondence is used for representing which articles are stored in which article storage unit. For example, for an identifier of a drawer is A, acquired tag information of articles stored in the drawer includes 001 and 002, the identifier A corresponds to the tag information 001 and 002, this correspondence may represent two logistic parcels stored in the drawer A, and the logistic parcels are two logistic parcels provided with tag information 001 and tag information 002.

It should be noted that one or more article storage units may be disposed in the transporting vehicle. If there is one article storage unit, the transporting vehicle can be used as an article storage unit. If the transporting vehicle is provided with a plurality of article storage units, the transporting vehicle needs to acquire an identifier of each article storage unit and tag information of an article in each article storage unit by using the foregoing method. If no article is placed into an article storage unit, tag information of an article inside the article storage unit is blank.

S205: The transporting vehicle sends the identifier of the article storage unit and tag information corresponding to the article storage unit to the server.

If one article storage unit is disposed in the transporting vehicle, that is, the transporting vehicle is the article storage unit, sending the identifier of the article storage unit is sending the identifier of the transporting vehicle. If the transporting vehicle is provided with a plurality of article storage units, the transporting vehicle needs to send an identifier of each article storage unit and tag information corresponding to the article storage unit to the server.

The transporting vehicle may send one identifier of an article storage unit and tag information corresponding to the article storage unit at a time, and may alternatively send identifiers of a plurality of article storage units and tag information corresponding to each article storage unit at a time. For example, the transporting vehicle may send identifiers of all article storage units and tag information corresponding to the article storage units to the server at a time.

For example, the transporting vehicle is provided with drawers, namely, a drawer A, a drawer B, and a drawer C. If tag information corresponding to the drawer A includes 001 and 002, tag information corresponding to the drawer B includes 004, 006, and 007, and tag information corresponding to the drawer C includes 003, the transporting vehicle can send A[001,002], B[004,006,007], and C[003] to the server.

It should be noted that after the transporting vehicle sends tag information corresponding to all of the article storage units to the server, it indicates that the transporting vehicle completes article loading.

S206: The server stores the identifier of the article storage unit and the tag information corresponding to the article storage unit.

It may be understood that if the server manages a plurality of transporting vehicles, and identifiers of article storage units of the transporting vehicles may be the same, the transporting vehicles also need to send identifiers of the transporting vehicles. In this way, instead of only storing the identifier of the article storage unit and the tag information corresponding to the article storage unit, the server stores relationships among the two and the identifier of the transporting vehicle.

The server stores the foregoing identifiers of all of the article storage units and tag information corresponding to the article storage units, and after it is indicated that article loading of the transporting vehicle is completed, the server records which articles are placed into the article storage units of the transporting vehicle. Using the same example as described above, correspondences between the drawer identifiers and the tag information that are stored on the server are A[001,002], B[004,006,007], and C[003].

It should be noted that the server stores tag information corresponding to an article storage unit, and the tag information may represent an article. Thus, the server may pre-record an article set corresponding to the article storage unit. The article set may be referred to as a first article set. Certainly, the first article set may be pre-recorded on another device other than the server. When the article transporting method is performed, the server obtains the first article set from another device. The article set may not be tag information and may alternatively be another identifier capable of uniquely representing an article.

The first article set is changeable, and each time an article is successfully delivered by the transporting vehicle, the article can be deleted from the article set.

S207: The server compares the tag information corresponding to the article storage unit with the tag information corresponding to the scan code information, if they are different, performs step S208, and if they are the same, performs step S210.

In actual applications, there may be a situation that an operator forgets to place an article in a transporting task into the article storage unit or additionally places an article into the article storage unit. To remind the operator after this situation occurs, whether the article in the article storage unit is the same as the article in the transporting task is determined by comparison.

Specifically, the server stores a correspondence between scan code information and tag information, and can determine which articles need to be transported in this transporting task by obtaining all correspondences. In addition, the server stores tag information corresponding to all article storage units of the transporting vehicle in step S206, and the tag information may represent which articles are loaded in the transporting vehicle. Further, all pieces of tag information corresponding all the article storage units are compared with all pieces of tag information corresponding to all scan code to determine whether they are the same. If a quantity of pieces of the former tag information is less than the a quantity of pieces of the latter tag information, it indicates that a quantity of articles loaded in the transporting vehicle is smaller than articles in the transporting task.

For example, all of pieces of tag information corresponding to all the article storage units are tag information in [001,aaa], [002,bbb], [003,ccc], [004,ddd], [005,eee], [006,fff], and [007,ggg]. All of pieces of identifier information corresponding to all the article storage units are tag information in A[001,002], B[004,006,007], and C[003]. It could be found after comparison that tag information 005 is missed from the tag information corresponding to the article storage units, indicating that an article corresponding to the tag information 005 is not placed into the article storage unit of the transporting vehicle.

In actual applications, there may be a situation that quantities of pieces of tag information are the same, but contents are different. Therefore, the comparison is not limited to the quantities of pieces of tag information, contents of the tag information may alternatively be compared, and if the contents of the tag information are different, step S208 is also performed.

S208: The server sending first prompting information to the transporting vehicle, where the first prompting information is used for prompting that verification on an article loaded in the transporting vehicle fails.

The server generates prompting information and sends the prompting information to the transporting vehicle. To facilitate distinguishing the prompting information from other prompting information, the prompting information is referred to as first prompting information.

S209: The transporting vehicle outputs the first prompting information. If the transporting vehicle receives a correction completion instruction, the process returns to step S204 until a determining result in step S207 is the same.

After receiving the first prompting information, the transporting vehicle outputs the first prompting information in an outputting manner corresponding to a form of the first prompting information. For example, the first prompting information may be text, an image, or the like, and the first prompting information is displayed on the display screen. For another example, the first prompting information is a sound, and the output first prompting information is output by using a sound outputting device. The first prompting information is used for prompting that verification on the articles loaded by the operator fails.

Certainly, a reason for the verification failure may also be further prompted in the first prompting information. For example, a comparison result is that a quantity of pieces of tag information corresponding to the article storage unit is less than a quantity of pieces of tag information corresponding to the scan code information, and a reason prompted in the first prompting information is that not all the articles in the transporting task are placed into the article storage unit. If a comparison result is that the quantity of pieces of tag information corresponding to the article storage unit is the same as the tag information corresponding to the scan code information, but the contents are different, a reason prompted in the first prompting information is that articles in the article storage unit are different from articles in the transporting task. If a comparison result is that a quantity of pieces of tag information corresponding to the article storage unit is larger than a quantity of pieces of tag information corresponding to the scan code information, a reason prompted in the first prompting information is that articles placed into the article storage unit are more than articles in the transporting task.

Still further, the first prompting information of the server may further include information of an article where an error occurs. For example, for an article that is not placed into the article storage unit, scan code information or another identifier of the article is determined according to tag information of the article, and the two-dimensional barcode information or another identifier is added into the first prompting information and sent. Using the above example, if it is determined that missed tag information is 005, it can be determined, according to an correspondence between the tag information and scan code information, that the scan code information corresponding to the tag information is eee, so that the scan code information can be added into the first prompting information and sent to the transporting vehicle, to facilitate an operator of rapidly determining the error.

If the operator finds, according to the prompting information, that an article is indeed mistakenly placed, additionally placed, or missed, the operator corrects an article placed into the article storage unit according to the finding. After the correction is completed, the operator may input a correction completion instruction to the transporting vehicle by using the human-machine interface, and after receiving the correction completion instruction, the transporting vehicle may be configured to return to step S204 to perform verification on the corrected article again. Alternatively, to simplify an implementation, the transporting vehicle may alternatively configured to directly perform step S210.

In some special cases, after receiving the prompting information, the operator determines that it is not needed to correct an article, and the transporting vehicle can directly transport the article. The operator may directly input a correction completion instruction by using an human-machine interface, and after receiving the correction completion instruction, the transporting vehicle may send prompting information to the server, to enable the server to perform step S210.

In addition, if the transporting vehicle is configured to, after receiving the correction completion instruction, return to step S204, a human-machine interface used for inputting an article loading completion instruction may be further set on the transporting vehicle. The operator may input an article loading completion instruction by using the human-machine interface, and after receiving the article loading completion instruction, the transporting vehicle performs step S210.

S210: The server plans a transporting route according to receiving locations of the articles in the article transporting task.

The server determines which articles are included in the transporting task, and determines receiving locations of the articles. A transporting route of the transporting vehicle is planned according to receiving locations of the articles and maps of sites where the receiving locations are. The transporting route includes receiving locations corresponding to all the articles. One receiving location may correspond to one or more articles. If one receiving location corresponds to a plurality of articles, it indicates that the plurality of articles has a same receiving location.

S211: The server sends the transporting route to the transporting vehicle.

The server sends the transporting route planned for this transporting task to the transporting vehicle.

S212: The transporting vehicle moves according to the transporting route, and sends a moving location to the server in a movement process.

The transporting vehicle may be provided with a navigation module and moving component. The navigation module may instruct the moving component to move according to a path indicated by the transporting route. In addition, in the movement process, the transporting vehicle may report a real-time location in the movement process to the server at preset time intervals.

S213: The server determines, according to the moving location sent by the transporting vehicle, whether the transporting vehicle arrives at a receiving location of an article. If a determining result is yes, step S214 is performed; if a determining result is not, step S213 is performed again at a later time.

The server may monitor the movement process of the transporting vehicle, to determine whether the transporting vehicle arrives at a receiving location corresponding to an article included in the transporting task. Certainly, the transporting vehicle can monitor its own movement process. Specifically, the transporting route may further include a plurality of stop points, and the stop points correspond to receiving locations of the articles. In this way, in step S212, the transporting vehicle can determine whether itself arrives at a receiving location of an article, and if yes, stops moving, and sends notification information of arrival at receiving location to the server, to enable the server to generate a verification code for the article corresponding to the receiving location in step S214 and perform its subsequent steps.

S214: The server sends a movement stopping instruction to the transporting vehicle, generates a verification code for the article corresponding to the receiving location, and sends a pick-up notification to a communications terminal corresponding to the article, where the pick-up notification includes the verification code.

After the transporting vehicle arrives at a receiving location, the server determines which article corresponds to the receiving location, and generates a unique verification code for the article corresponding to the receiving location. If a plurality of articles corresponds to a same receiving location, a verification code is first generated for one of the articles, and the verification code is included in a pick-up notification, and sent to a communications terminal corresponding to the article. The communications terminal may be various devices such as a mobile terminal or a desktop computer. The pick-up notification may be in various forms such as an SMS message or messaging in an application program. The pick-up notification is used for notifying a recipient of receiving the article in the article storage unit.

It should be noted that an article pick-up procedure of this application may be set to be that a plurality of recipients at one receiving location picks up articles sequentially. Therefore, if one receiving location corresponds to a plurality of to-be-received articles, the server sequentially send verification codes to communications terminals corresponding to the plurality of articles, and after a pick-up procedure of a current article ends, sends a verification code to a communications terminal corresponding to another article. It this way, in one embodiment, it can be ensured that when the transporting vehicle is at a receiving location, the server only reserves one verification code for the transporting vehicle.

It should be noted that to facilitate description, an article corresponding to the receiving location is referred to as a to-be-received article. The step of generating a verification code for the article corresponding to the receiving location, and sending a pick-up notification to a communications terminal corresponding to the article may be not limited to being performed after sending a movement stopping instruction to the transporting vehicle, and may alternatively be performed after it is determined that a distance between the moving location of the transporting vehicle and a location of the receiving location falls within a preset distance threshold range, so that a pick-up notification can be sent to a recipient in advance, to reserve time for the recipient to arrive at the receiving location.

S215: After receiving the movement stopping instruction, the transporting vehicle stops moving and receives a verification code input by a user.

After the server sends the pick-up notification to the recipient of the article, and the recipient obtains the verification code in the pick-up notification, the verification code may be input to the transporting vehicle by using the human-machine interface disposed on the transporting vehicle.

S216: The transporting vehicle sends the verification code to the server.

After receiving the verification code, the transporting vehicle sends the verification code to the server.

S217: After receiving the verification code, the server determines whether the verification code is the same as the generated verification code, to obtain a verification code determining result.

It should be noted that the server generates a verification code for a recipient of an article in step S214, and after receiving the verification code sent by the recipient through the transporting vehicle, the server compares the received verification code with the verification code generated in step S214, to perform authentication to determine whether an identity of the recipient receiving the article is legal.

Specifically, if the comparison result is the same, a determining result indicating an authentication success is generated, and if the comparison result is different, a determining result indicating an authentication failure is generated. In addition, if the comparison result indicates an authentication success, the server may further determine tag information of the article corresponding to the verification code, and determine, according to a correspondence between the tag information and an identifier of an article storage unit, an identifier of the article storage unit where the article is, adds the identifier of the article storage unit to the verification code determining result, and sends them together to the transporting vehicle.

It should be noted that authentication performed by the server on the verification code further includes authentication on a time. Specifically, the server determines whether a time interval between a time of receiving the verification code from the transporting vehicle and a time of generating the verification code is within a preset time interval, if the time interval is in the preset time interval, further determines whether the verification code is the same as the generated verification code, and if the time interval is not in the preset time interval, no longer determines the content of the verification code and generates a determining result indicating an authentication failure.

In addition, the authentication performed by the server on the verification code may further include authentication on a number of times of input. Specifically, as stated above, when the transporting vehicle is at a receiving location, the server reserves one verification code for the transporting vehicle. In this way, after generating the verification code, and before determining that a pick-up procedure of the article corresponding to the verification code is completed, all verification codes that are sent by the transporting vehicle and that are received by the server are all considered to be verification codes for pick-up of the article. Therefore, after generating the verification code, and before determining that a pick-up procedure of the article corresponding to the verification code is completed, each time the server receives a verification code sent by the transporting vehicle, the server counts a number of times of sending a verification code by the transporting vehicle, if the number of times reaches a preset number of times threshold, no longer determines a content of the verification code and generates a determining result indicating an authentication failure, and if the number of times does not reach a preset number of times threshold, can determine a content of the verification code. A sequential execution order of the authentication on the number of times of input and the authentication on the time is not specifically limited in this application. The authentication on the number of times of input can be performed first, or the authentication on the time can be performed first, or they can be performed simultaneously.

S218: The server sends the verification code determining result to the transporting vehicle.

It could be learned from the description on step S217, according to an actual situation, the verification code determining result sent by the server to the transporting vehicle may indicate an authentication success or an authentication failure.

S219: If the verification code determining result indicates an authentication success, the transporting vehicle opens, according to an identifier of an article storage unit in the verification code determining result, an article storage unit corresponding to the identifier of the article storage unit, and if the verification code determining result indicates an authentication failure, the transporting vehicle outputs information of the authentication failure.

After receiving the verification code determining result, the transporting vehicle performs different actions according to whether the verification code determining result indicates an authentication success or an authentication failure. If the verification code determining result indicates an authentication success, the transporting vehicle may open, according to the identifier of the article storage unit in the verification code determining result, the article storage unit, so that the recipient can take away the article.

For example, when the transporting vehicle arrives at a receiving location, tag information of a to-be-received article corresponding to the receiving location is 007, and it could be learned from the example in step S207, the article is placed in the drawer B. Therefore, after receiving the verification code determining result indicating a success, the transporting vehicle opens the drawer B, so that the recipient can take way the article.

If the verification code determining result indicating an authentication failure, the transporting vehicle outputs prompting information in various forms such as text output of the display screen or voice output of a sound outputting device. The transporting vehicle may return to step S215 to receive a verification code input by the user again and perform subsequent steps.

S220: After detecting that the article storage unit is closed, the transporting vehicle acquires tag information in the article storage unit.

Because one article storage unit can store a plurality of articles, to prevent a recipient from mistakenly picking up an article, authentication may be performed on an article taken away by the recipient. Specifically, after taking away the article, the recipient may input an instruction of closing the article storage unit to the transporting vehicle. Once the transporting vehicle receives the instruction of closing the article storage unit, the transporting vehicle may trigger the tag information acquisition unit in the article storage unit re-acquire tag information of an article in the article storage unit. For a detailed acquisition manner, refer to the preceding description. Details are not described herein.

S221: The transporting vehicle sends the identifier of the article storage unit and the acquired tag information of articles stored in the article storage unit to the server.

The identifier and the tag information of the article storage unit sent in this step may only include the identifier of the article storage unit and corresponding tag information of articles stored in the article storage unit. The previous example is still used as an example. In this step, the drawer identifier and the tag information sent by the transporting vehicle are B[004,006].

It should be noted that the tag information corresponding to the article storage unit may be used for representing an article. Therefore, it could be considered that a set of tag information sent by the transporting vehicle is used for representing an article set corresponding to the article storage unit.

In the description of step S206, the article set is referred to as the first article set. To facilitate distinguishing, the article set in this step may be referred to as a second article set. The first article set is an article set before an article storage unit in which a specific article is placed is opened, and the second article set is an article set after the article storage unit in which the article is placed is opened. Which article is taken away can be determined by comparing the two article sets.

S222: The server determines tag information corresponding to the identifier of the article storage unit and compares the determined tag information with the received tag information, to obtain inconsistent tag information.

As stated above, in step S206, the server records a correspondence of an identifier and tag information of an article storage unit. The correspondence is generated during article loading of the transporting vehicle and may represent which articles are placed into each article storage unit of the transporting vehicle. In addition, a correspondence of an identifier and tag information of an article storage unit received by the server in step S222 is generated after the recipient complete one article pick-up procedure, and may represent which articles remain in the article storage unit after one article pick-up procedure is completed. Therefore, after the server compares the two, the obtained inconsistent tag information present which article or articles is or are taken away by the recipient.

For example, the drawer identifier and the tag information received by the server in step S222 are B[004, 006], and the server searches the correspondences recorded in step S206 for tag information [004, 006, 007] corresponding to the drawer identifier B, and then, can determine, by comparing the received tag information [004, 006] with the found tag information [004, 006, 007], that the inconsistent tag information is 007, representing that the article taken away by the recipient is an article with tag information 007.

It should be noted that the determining tag information means determining a target article. The target article is used for presenting an article corresponding to a location of the transporting vehicle. The location of the transporting vehicle may be a location where the second article set is sent, and the location may be referred to as a target location. The location where the second article set is sent may be a receiving location or a location close to a receiving location in the transporting route. The location close to the receiving location may be a location whose distance to the receiving location falls within a specific distance range.

An implementation for determining a target article may be determining the target article according to a location of the transporting vehicle sending second article set. Specifically, a target location of the transporting vehicle is determined, and the target article corresponding to the target location is determined according to a pre-recorded correspondence between a location of the transporting vehicle sending the second article set and an article. Alternatively, another implementation for determining a target article may be determining the target article according to a verification code input by the transporting vehicle. Specifically, a verification code sent by the transporting vehicle is obtained, and the target article corresponding to the verification code is determined according to a correspondence between a verification code and an article. To ensure implementation of such a manner, when the verification code is generated, a correspondence between the verification code and an article can be established. Alternatively, no correspondence is established between the verification code and an article, and instead, a target article corresponding to the verification code is determined according to a correspondence between the verification code and a user and a correspondence between the user and an article.

S223: The server compares the inconsistent tag information with the tag information of the article corresponding to the receiving location, if they are different, performs step S224, and if they are the same, performs step S226.

It is described in step S214 that the server determines which article or articles is or are a to-be-received article or to-be-received articles at the receiving location, and the to-be-received article or the to-be-received articles is or are provided with tag information. Therefore, the server compares the consistent tag information determined in the previous step with the tag information of the to-be-received article or to-be-received articles, if they are the same, indicating that the article or articles taken away by the recipient is or are correct, performs step S225, and if they are different, indicating that the article or articles taken away by the recipient is or are incorrect, performs step S224.

The previous example is still used as an example. The inconsistent tag information obtained after comparison is 007, and the tag information of the to-be-received article determined in step S219 is also 007. Therefore, the server performs step S226.

It should be noted that if the two pieces of tag information are the same, indicating that the transporting vehicle successfully perform delivery, the tag information can be deleted from the first article set.

S224: The server sends alarm information to the transporting vehicle.

The server generates alarm information, and the alarm information is used for prompting a pick-up error to the recipient.

S225: The transporting vehicle gives an alarm according to a prompt of the alarm information until receiving an alarm releasing instruction.

An alarm of the transporting vehicle may be in various forms such as text or a sound. For example, a sound outputting device of the transporting vehicle outputs an alarm sound. In an example, the transporting vehicle can keep on giving an alarm until receiving an alarm releasing instruction. The alarm releasing instruction may be input by the recipient by using the human-machine interface of the transporting vehicle and may be generated after the transporting vehicle detects that the article placed back to the article storage unit. The transporting vehicle may detect whether an article is placed back to an article storage unit in various manners. One of the detecting manners is performing detection according to the foregoing step S220 and subsequent steps.

S226: The server determines whether the pick-up procedure is completed on all of the articles corresponding to the receiving location, if yes, performs step S227, and if not, performs step S232.

Step S214 to step S223 are a pick-up procedure of one article corresponding to the receiving location. Therefore, in step S226, it is first determined whether the pick-up procedure is completed on all of the articles corresponding to the receiving location, and if the pick-up procedure is completed on all of the articles, step S227 can be performed, so that the transporting vehicle moves toward a next receiving location. If the pick-up procedure is not completed on all of the articles corresponding to the receiving location, step S232 can be performed, to enable the server to generate a verification code for another article corresponding to the receiving location.

S227: The server determines whether a receiving location is a final receiving location in the transporting route, if not, performs step S228, and if yes, performs step S230.

A destination of the transporting route may be a final receiving location. That is, the transporting route only guides the transporting vehicle to respective receiving locations. In another implementation, the transporting route may further include a returning route, and the returning route is used for guiding the transporting vehicle to return to a preset returning location.

S228: The server sends a moving instruction to the transporting vehicle.

The moving instruction is used for instructing the transporting vehicle to continue to move according to the transporting route.

S229: After receiving the moving instruction, the transporting vehicle continues to move according to the transporting route, sends a moving location to the server in a movement process, and returns to step S213.

S230: The server sends a returning instruction to the transporting vehicle.

If the transporting route does not include a returning route, the server determines a route of the transporting vehicle from the receiving location to the preset returning location point, where this route is the returning route, and the server adds the returning route into the returning instruction. If the transporting route includes a returning route, the returning instruction does not need to include a returning route.

S231: After receiving the returning instruction, the transporting vehicle determines a returning route according to the returning instruction, and moves to a preset returning location point according to the returning route.

If the returning instruction includes a returning route, the transporting vehicle uses the returning route in the returning instruction as the determined returning route and if the returning instruction does not include a returning route, the transporting vehicle uses the returning route in the transporting route as the determined returning route.

Certainly, in this embodiment, an article returning procedure may be further included. That is, the server determines that the article storage unit of the transporting vehicle includes an article that is not picked up, sends an article returning instruction to the transporting vehicle, and sends an article returning list to an information acquisition terminal of an operator. After receiving the article returning instruction, the transporting vehicle moves to a designated article returning location, and the operator can receive, according to article returning list shown on the information acquisition terminal, the article in the article storage unit of the transporting vehicle, to complete an article returning procedure.

S232: The server generates a verification code for another article corresponding to the receiving location, and sends a pick-up notification to a communications terminal corresponding to the another article, where the pick-up notification includes the verification code; and returns to perform the step of receiving a verification code by a user in step S215.

It could be learned from the foregoing technical solutions that this application provides an article transporting method. In this method, one or more articles can be placed in the article storage unit disposed in the transporting vehicle, so that a utilization ratio of the article storage unit is improved. In addition, in this application, a tag is placed on an article, a tag information acquisition unit is disposed in the transporting vehicle, and tag information of each article in the article storage unit may be acquired and uploaded to the server. After the transporting vehicle arrives at a receiving location of a specific article, the server can determine, by comparing tag information in the article storage unit before article transporting of the transporting vehicle with tag information in the article storage unit after an article is taken away at the receiving location, an article that is taken away by a user, and further, compares the article that is taken away with a to-be-received article at this receiving location, to determine whether the article taken away by the user is correct. In view of this, the article transporting method provided by this application can ensure accuracy of pick-up of a user while improving a utilization ratio of the article storage unit.

It could be understood that after arriving at a receiving location of a specific article, the transporting vehicle needs to wait for re-acquiring tag information in the article storage unit after the recipient takes away the article. In step S220 of the foregoing embodiment, whether the recipient has taken away the article is determined by detecting whether the article storage unit is closed. However, a method for determining whether an article is taken away is not limited to the above, and may alternatively be determining whether a stay time length of the transporting vehicle at the receiving location reaches a preset time length. Such a situation is more suitable for being applied to a scenario where the article storage unit of the transporting vehicle does not need to be opened and closed. Certainly, the preset time length is merely an exemplary description, and there may be another preset condition.

It should be noted that if the preset time length is used as a preset condition, and one receiving location corresponds to a plurality of articles, the articles have respective preset time lengths, and the preset time lengths of the articles may be the same or different.

Referring to FIG. 4, FIG. 4 is a schematic structural diagram of hardware of a server according to this application. The server may be a computer device. As shown in FIG. 4, the server includes: a memory 401, a communications interface 402, a processor 403, and one or more buses 404.

The memory 401, the communications interface 402, and the processor 403 are connected to each other through the buses 404.

The memory 401 is configured to provide a first article set corresponding to a transporting vehicle.

The communications interface 402 is configured to receive a second article set corresponding to the transporting vehicle that is sent by the transporting vehicle.

The processor 403 is configured to determine a target article; determine a difference article between the first article set and the second article set; determine whether the difference article is the target article, and generate determining result information.

The communications interface 402 is further configured to send the result information to the transporting vehicle.

In an example, the first article set is specifically a first article tag set, and the second article set is specifically a second article tag set.

When performing the step of determining a difference article between the first article set and the second article set, the processor 403 is specifically configured to determine a difference article tag between the first article tag set and the second article tag set; and the determining whether the difference article is the target article includes: determining whether an article corresponding to the difference article tag is the target article.

In an example, the first article set includes a plurality of subsets, and different subsets correspond to difference article storage units disposed in the transporting vehicle.

In an example, when performing the step of receiving a second article set corresponding to the transporting vehicle that is sent by the transporting vehicle, the communications interface 402 is specifically configured to receive the second article set corresponding to a target article storage unit of the transporting vehicle that is sent by the transporting vehicle.

When performing the step of determining a difference article between the first article set and the second article set, the processor 403 is specifically configured to determine, in the first article set, a target subset corresponding to the target article storage unit; and determine a difference article between the target subset and the second article set.

In an example, when performing the step of determining a target article, the processor 403 is specifically configured to determine a target location of the transporting vehicle sending the second article set; and determine, according to a pre-recorded correspondence between a location of the transporting vehicle sending the second article set and an article, the target article corresponding to the target location.

In an example, the processor 403 is further configured to generate an article transporting task.

The communications interface 402 is further configured to send the article transporting task to an information acquisition terminal or the transporting vehicle, where the article transporting task is used for being displayed on the information acquisition terminal or the transporting vehicle, so as to for a user to store an article in the article transporting task to the transporting vehicle.

In an example, the processor 403 is further configured to compare articles in the first article set with articles in the article transporting task.

The communications interface 402 is further configured to, if the articles in the first article set are inconsistent with the articles in the article transporting task, send a first prompt message to the transporting vehicle, where the first prompt message is used for prompting that verifications on articles loaded on the transporting vehicle fails.

In an example, the processor 403 is further configured to, if a quantity of the articles in the first article set is less than a quantity of the articles in the article transporting task, determine a missed article in the first article set.

When performing the step of sending a first prompt message to the transporting vehicle, the communications interface 402 is specifically configured to send an identifier of the missed article to the transporting vehicle.

In an example, the processor 403 is further configured to plan a transporting route according to receiving locations of the articles in the article transporting task; and the communications interface 402 is further configured to send the transporting route to the transporting vehicle.

In an example, the communications interface 402 is further configured to receive a moving location sent by the transporting vehicle; the processor 403 is further configured to, if the moving location corresponds to a receiving location of an article in the article transporting task, generate a movement stopping instruction; and the communications interface 402 is further configured to send the movement stopping instruction to the transporting vehicle.

In an example, the processor 403 is further configured to, if the moving location corresponds to the receiving location of the article in the article transporting task, generate a pick-up notification including a verification code; and the communications interface 402 is further configured to send the pick-up notification to a communications terminal corresponding to the article.

In an example, the communications interface 402 is further configured to receive a verification code sent by the transporting vehicle; the processor 403 is further configured to, if the verification code sent by the transporting vehicle is the same as the verification code in the pick-up notification, generate an opening instruction; and the communications interface 402 is further configured to send the opening instruction to the transporting vehicle.

In an example, the processor 403 is further configured to, if the difference article is not the target article, generate alarm information; and when performing the step of sending the determining result to the transporting vehicle, the communications interface 402 is further configured to send the alarm information to the transporting vehicle.

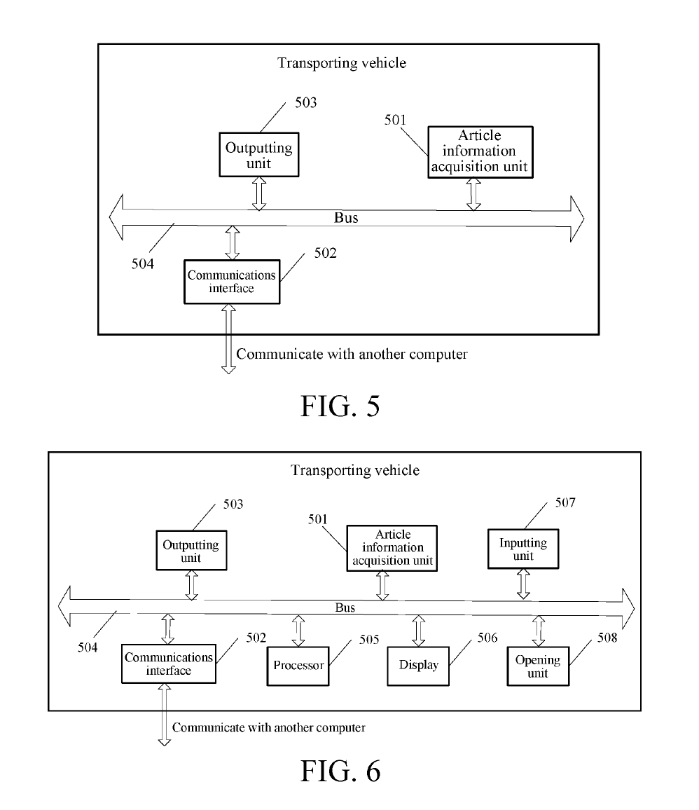

Referring to FIG. 5, FIG. 5 is a schematic structural diagram of a transporting vehicle according to this application. As shown in FIG. 5, the transporting vehicle specifically includes an article information acquisition unit 501, a communications interface 502, an outputting unit 503, and one or more buses 504.

The article information acquisition unit 501, the communications interface 502, and the outputting unit 503 are connected to each other through the buses 504.

The article information acquisition unit 501 is configured to obtain a first article transported by the transporting vehicle.

The communications interface 502 is configured to send the first article set corresponding to the transporting vehicle to a server.

The article information acquisition unit 501 is further configured to, after a preset condition is satisfied, obtain a second article set corresponding to the transporting vehicle.

The communications interface 502 is further configured to send the second article set corresponding to the transporting vehicle to the server, where the second article set is provided for the server to determine a corresponding target article.

The first article set and the second article set are provided for the server to: determine a difference article, determine whether the difference article is the target article, and send determining result information to the transporting vehicle.

The outputting unit 503 is configured to receive and output the result information.

The article information acquisition unit 501 is disposed on the transporting vehicle. The article information acquisition unit 501 may be a tag reader, for example, a scanner, sensor, or other detector. For example, the tag information acquisition unit may be an RFID tag reader. The outputting unit 503 may be an audio outputting device, a video outputting device, a display, or the like.

In an example, when performing the step of obtaining a first article set transported by the transporting vehicle, the article information acquisition unit 501 is specifically configured to obtain article tags of articles transported by the transporting vehicle, and use a set of the article tags as the first article set.

In an example, the transporting vehicle includes a plurality of article storage units, and when performing the step of obtaining a first article set transported by the transporting vehicle, the article information acquisition unit 501 is specifically configured to obtain article subsets corresponding to the respective article storage units in the transporting vehicle, and uses a set constituted by the respective article subsets as the first article set.

In an example, when performing the step of, after a preset condition is satisfied, obtaining a second article set corresponding to the transporting vehicle, the article information acquisition unit 501 is specifically configured to obtain, after the preset condition is satisfied, an article subset corresponding to a target article storage unit in the transporting vehicle, and uses the article subset as the second article set.

Referring to FIG. 6, FIG. 6 is a schematic structural diagram of another transporting vehicle according to this application. As shown in FIG. 6, in addition to including the structure shown in FIG. 5, the transporting vehicle further includes: a processor 505, a display 506, an inputting unit 507, and opening unit 508.

The processor 505 is configured to detect whether the transporting vehicle is closed or detect whether a stay time length of the transporting vehicle reaches a preset time length, where that the transporting vehicle is closed or that a stay time length of the transporting vehicle reaches a preset time length is used for presenting that the preset condition is satisfied.

The display 506 is configured to display an article transporting task sent by the server, so as to store an article in the article transporting task to the transporting vehicle.

It should be noted that, in some embodiments, the processor 505, the display 506, the inputting unit 507, and the opening unit 508 may not all disposed on a same transporting vehicle.

In an example, the communications interface 502 is further configured to receive a transporting route sent by the server, where the transporting route is planned according to receiving locations of the articles in the article transporting task. The processor 505 may be configured to control the transporting vehicle to sequentially move, according to the transporting route, to the receiving locations of the respective articles in the transporting task.

In an example, when performing the step of controlling the transporting vehicle to sequentially move, according to the transporting route, to the receiving locations of the respective articles in the transporting task, the processor 505 is specifically configured to control the transporting vehicle to move according to the transporting route, and send a moving location to the server.

The communications interface 502 is further configured to receive a movement stopping instruction sent by the server, where the movement stopping instruction is sent when the moving location corresponds to a receiving location of an article in the article transporting task.

In an example, the transporting route includes marked stop points corresponding to the receiving locations.

When performing the step of controlling the transporting vehicle to sequentially move, according to the transporting route, to the receiving locations of the respective articles in the transporting task, the processor 505 is specifically configured to control the transporting vehicle to move according to the transporting route, and stop moving after moving to a location corresponding to a marked stop point.

The inputting unit 507 is configured to receiving a verification code input by a user; the communications interface 502 is further configured to send the verification code to the server, where the verification code is provided for the server to: send, when the verification code is the same a verification code in a pick-up notification, an opening instruction to the transporting vehicle; and receive the opening instruction; and the opening unit 508 is configured to receive the opening instruction, and open the transporting vehicle. A lock may be disposed on the transporting vehicle, and the opening unit 508 may be an unlocking component.

In an example, when performing the step of receiving and outputting the result information, the outputting unit 503 is specifically configured to receive and output alarm information, where the alarm information is sent by the server when the difference article is not the target article.

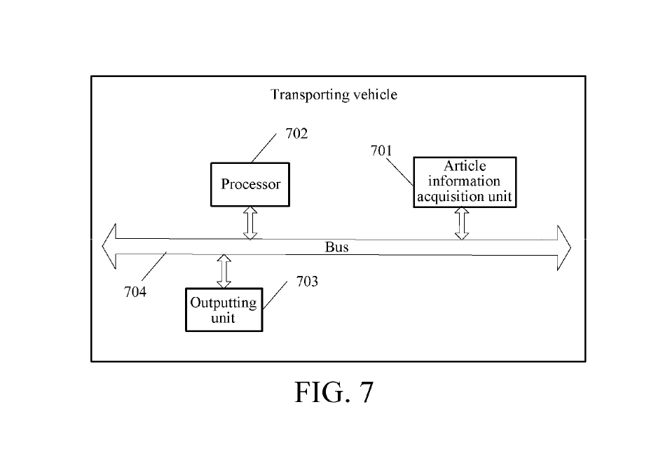

Referring to FIG. 7, FIG. 7 is a schematic structural diagram of still another transporting vehicle according to this application. As shown in FIG. 7, the transporting vehicle may specifically include an article information acquisition unit 701, a processor 702, an outputting unit 703, and one or more buses 704.

The article information acquisition unit 701, the processor 702, and the outputting unit 703 are connected to each other through the buses 704.

The article information acquisition unit 701 is configured to obtain a first article transported by the transporting vehicle; and after a preset condition is satisfied, obtain a second article set corresponding to the transporting vehicle.

The processor 702 is configured to determine a target article; determine a difference article between the first article set and the second article set; determine whether the difference article is the target article, and obtain a determining result.

The outputting unit 703 is configured to output the determining result.

The article information acquisition unit 701 may be specifically, a tag information acquisition unit such as an RFID tag acquisition unit.

It should be noted that embodiments in this specification are all describe progressively, and descriptions focus on differences distinguishing each embodiment from other embodiments. Mutual reference may be made for the same or similar parts between the respective embodiments.

In this application, relationship terms, such as first and second, are merely used for distinguishing an entity or operation from another entity or operation rather than requiring or implying existence of an actual relationship or sequence between the entities or operations. Moreover, terms, such as “include”, “comprise”, or any other variants, aim to covering non-exclusive inclusion, so that a process, a method, an article, or a device including a series of elements, not only includes the elements, but also includes other elements that are not explicitly listed or includes inherent elements of the process, the method, the article, or the device. Where there is no more limitation, an element defined by the wording “including a . . . ” does not exclude that additional same elements also exist in the process, the method, the article, or the device including the foregoing element.

The foregoing descriptions on the disclosed embodiments enable a person skilled in the art to implement or use the present application. Various modifications to the embodiments are obvious to a person skilled in the art. General principles defined in this application can be implemented in other embodiments without departing from the spirit or scope of the present application. Therefore, this application would not be limited to the embodiments shown in this application and conforms to the broadest scope consistent with the principles and novel features disclosed in this application.

What is claimed is:

1. An article transporting method implementable by a computer device, comprising:
providing a first article set corresponding to a transporting vehicle;
receiving a second article set corresponding to the transporting vehicle that is sent by the transporting vehicle;
determining a target article;
determining a difference article between the first article set and the second article set; and
determining whether the difference article is the target article, and sending determining result information to the transporting vehicle.

2. The article transporting method according to claim 1, wherein the first article set is a first article tag set, and the second article set is a second article tag set;
the determining a difference article between the first article set and the second article set comprises:
determining a difference article tag between the first article tag set and the second article tag set; and
the determining whether the difference article is the target article comprises:
determining whether an article corresponding to the difference article tag is the target article.

3. The article transporting method according to claim 1, wherein the first article set comprises a plurality of subsets, and different subsets correspond to difference article storage units disposed in the transporting vehicle.

4. The article transporting method according to claim 3, wherein the receiving a second article set corresponding to the transporting vehicle that is sent by the transporting vehicle comprises:
receiving the second article set corresponding to a target article storage unit of the transporting vehicle that is sent by the transporting vehicle; and
the determining a difference article between the first article set and the second article set comprises:
determining, in the first article set, a target subset corresponding to the target article storage unit; and
determining a difference article between the target subset and the second article set.

5. The article transporting method according to claim 1, wherein the determining a target article comprises:
determining a target location of the transporting vehicle; and
determining, according to a pre-recorded correspondence between a location of the transporting vehicle sending the second article set and an article, the target article corresponding to the target location.

6. The article transporting method according to claim 1, further comprising:
generating an article transporting task, and sending the article transporting task to an information acquisition terminal or the transporting vehicle.

7. The article transporting method according to claim 6, further comprising:
comparing articles in the first article set with articles in the article transporting task; and
if the articles in the first article set are inconsistent with the articles in the article transporting task, sending a first prompt message to the transporting vehicle, wherein the first prompt message is used for prompting that verification on articles loaded on the transporting vehicle fails.

8. The article transporting method according to claim 7, wherein the sending a first prompt message to the transporting vehicle comprises:
if a quantity of the articles in the first article set is less than a quantity of the articles in the article transporting task, determining a missed article in the first article set; and
sending an identifier of the missed article to the transporting vehicle.

9. The article transporting method according to claim 6, further comprising:
planning a transporting route according to receiving locations of the articles in the article transporting task; and
sending the transporting route to the transporting vehicle.

10. The article transporting method according to claim 9, further comprising:
receiving a moving location sent by the transporting vehicle; and
if the moving location corresponds to a receiving location of an article in the article transporting task, sending a movement stopping instruction to the transporting vehicle.

11. The article transporting method according to claim 9, further comprising:
if the moving location corresponds to the receiving location of the article in the article transporting task, sending a pick-up notification comprising a verification code to a communications terminal corresponding to the article.

12. The article transporting method according to claim 11, further comprising:
receiving a verification code sent by the transporting vehicle; and
if the verification code sent by the transporting vehicle is the same as the verification code in the pick-up notification, sending an opening instruction to the transporting vehicle.

13. The article transporting method according to claim 11, wherein the sending determining result information to the transporting vehicle comprises:
if the difference article is not the target article, sending alarm information to the transporting vehicle.

14. An article transporting method implementable by a transporting vehicle comprising:
obtaining a first article set transported by the transporting vehicle, and sending the first article set corresponding to the transporting vehicle to a server;
obtaining a second article set corresponding to the transporting vehicle when a preset condition is satisfied, and sending the second article set corresponding to the transporting vehicle to the server, wherein the second article set is provided for the server to determine a corresponding target article, wherein
the first article set and the second article set are provided for the server to: determine a difference article, determine whether the difference article is the target article, and send determining result information to the transporting vehicle; and
receiving and outputting the result information.

15. The article transporting method according to claim 14, wherein the obtaining a first article set transported by the transporting vehicle comprises:
obtaining article tags of articles transported by the transporting vehicle, and using a set of the article tags as the first article set.

16. The article transporting method according to claim 14, wherein the transporting vehicle comprises a plurality of article storage units, and the obtaining a first article set transported by the transporting vehicle comprises:
obtaining article subsets corresponding to the respective article storage units in the transporting vehicle, and using a set constituted by the respective article subsets as the first article set.

17. The article transporting method according to claim 16, wherein the obtaining a second article set corresponding to the transporting vehicle when a preset condition is satisfied comprises:
obtaining, after the preset condition is satisfied, an article subset corresponding to a target article storage unit in the transporting vehicle, and using the article subset as the second article set.

18. The article transporting method according to claim 14, wherein the preset condition comprises:
detecting that the transporting vehicle is closed; or detecting that a stay time length of the transporting vehicle reaches a preset time length.

19. The article transporting method according to claim 14, further comprising:
receiving a transporting route sent by the server, wherein the transporting route is planned according to receiving locations of the articles in the article transporting task; and
sequentially moving, according to the transporting route, to the receiving locations of the respective articles in the transporting task. difference article

20. An article transporting method implementable by a transporting vehicle, comprising:
obtaining a first article set transported by the transporting vehicle;
after a preset condition is satisfied, obtaining a second article set corresponding to the transporting vehicle;
determining a target article;
determining a difference article between the first article set and the second article set; and
determining whether the difference article is the target article and outputting a determining result.
